(19) United States
(12) Patent Application Publication
(10) Pub. No.: US 2024/0000039 A1
(43) Pub. Date: Jan. 4, 2024

(54) SYSTEM AND METHOD FOR SANITARY DISPOSAL OF PET EXCRETA

(71) Applicant: Bruce Ahn, Castle Rock, CO (US)

(72) Inventors: Bruce Chen Ahn, Castle Rock, CO (US); Elvis Chen Ahn, Castle Rock, CO (US); Lucian Chown, Princeton Junction, NJ (US); Prathamesh Sunil Bang, South Windsor, CT (US); Ohad Koronyo, Los Angeles, CA (US)

(21) Appl. No.: 17/857,119

(22) Filed: Jul. 4, 2022

(51) Int. Cl. A01K 13/00; A01K 23/00

(52) U.S. Cl. CPC A01K 13/006; A01K 23/00

(57) ABSTRACT

A system for sanitary handling of animal excrement is provided comprising a mixing device that combines substances comprising an active ingredient, a water repellent, and a solvent to create a solution that when applied to animal fur binds to the fur and prevents animal feces from adhering to the fur. The solution is applied as a spray. The solution is of low viscosity that promotes the application as a spray The solution is non-toxic, is silicone-based, and is chemically stable. The active ingredient is an amine-based silicone that is hydrophilic.

### CROSS REFERENCE TO RELATED APPLICATIONS

None

### FIELD OF THE APPLICATION

The present disclosure is in the field of pet care. More particularly, the present disclosure provides systems and methods of creating a silicone-based solution that when sprayed at a pet's backside causes freshly excreted feces to slide off for disposal.

### BACKGROUND

Owners of dogs and other animals have an unsavory problem that is not widely discussed, mainly because it is not pleasant: small clumps of feces get stuck in their dogs' fur after the dogs defecate. When a dog defecates, particularly a long-haired dog, feces often adhere to the dog's fur. The feces can be irritating to the dog and present health risks to the dog after it dries and remains stuck on the dog's backside.

Dog feces can also stain carpet, furniture, clothing, and automobile interiors as well as present health risks to humans, particularly young children. Short of bathing the dog, there is little that a dog owner can do to completely clear damp or dried feces from a dog's backside.

### BRIEF DESCRIPTION OF THE DRAWINGS

FIG. 1 is a block diagram of a system of sanitary disposal of pet excreta according to an embodiment of the present disclosure.

FIG. 2 is an image of a system of sanitary disposal of pet excreta according to an embodiment of the present disclosure.

FIG. 3 is an image of a system of sanitary disposal of pet excreta according to an embodiment of the present disclosure.

### DETAILED DESCRIPTION

Systems and methods described herein provide a spray application for the repellent of dog fecal matter from dog fur. A liquid or aerosol spray that may be in a pressurized container. A user sprays a dog's backside with the substance moments before the dog defecates. The spray adheres to fur or hair on the dog's backside that might normally become caked with feces as the dog defecates.

After the spray is applied and the dog proceeds to relieve himself, the feces does not adhere to the fur or hair as it normally does and instead slides off or is easy to remove by the owner using a cloth, napkin, paper towel or newspaper. The dog's backside is then clear and there is less of a risk of mess once the dog is back indoors. The dog is likely to be happier and more comfortable.

The spray is made from three non-toxic silicone-based liquid ingredient that are mixed and dispensed from a container as spray. Dog fur is primarily made of protein and is negatively charged. The spray provided herein is anime-based and is positively charged. It is also of low viscosity so it may be readily dispensed as spray.

The spray is a three-part silicone-based chemical comprising of the following:
1) Amine based silicone (active ingredient, amine is hydrophilic, 2.5%-5.0% of volume)
2) Hydrophobic silicone (repels water, 1.0%-2.0% of volume)
3) Solvent (low molecular silicone which evaporates easily, 93.0%-96.5%)

The three substances are combined according to the above formula. After mixing for five to ten minutes a clear and uniform solution should form. The solution can be loaded into a non-aerosol spray bottle and will be ready for use.

Whereas feces, whether freshly excreted or excreted hours or days ago and hence dry and stuck to the dog's fur or hair, normally adheres to the fur, the systems and methods of the present disclosure prevents feces from sticking to the fur or hair and later coming in contact with the user's carpet or furniture. The spray may be made of beeswax and carnauba wax that owners can spray on their dogs' backsides, making the feces slide right off the fur. In an embodiment, the spray may be made of another chemical, substance or combination thereof.

While discussion above is focused on dogs as pets and problems associated with dog feces, systems and methods provided herein may also apply to other kinds of pets as well as agricultural animals such as livestock as well as zoo animals. Further, systems and methods may also be applicable to human users, for example with infirm or disabled persons with hair in their anal areas who may be assisted by caregivers in relieving themselves.

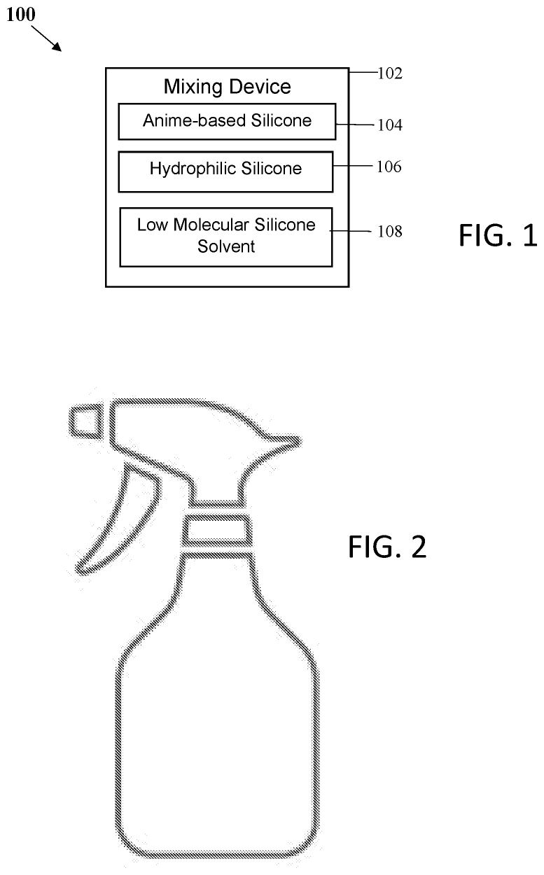

Turning to the figures, FIG. 1 is a block diagram of a system of sanitary disposal of pet excreta according to an embodiment of the present disclosure. FIG. 1 provides a simplified view of a system 100 comprising a mixing device 102 with ingredients provided herein including anime-based silicone 104, hydrophilic silicone 106, and low molecular silicone solvent 108.

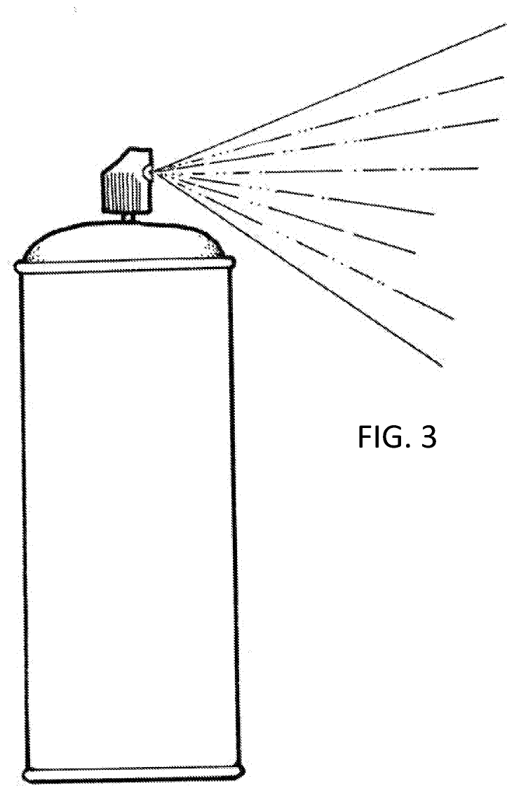

FIG. 2 and FIG. 3 are images of containers that may be used to dispense the spray described herein. FIG. 2 depicts a spray bottle in which the user squeezes a handle to the body of the spray bottle to dispense the spray. FIG. 3 is a traditional aerosol spray can wherein the user may with a single finger depress a nozzle at the top of the can to dispense the spray. In embodiments, the spray may be dispensed using containers and dispensing technology other than those depicted in FIG. 2 and FIG. 3.

Tests of the spray on dog hair and feces have been conducted. One test involved unwashed dog hair and a second test involved washed dog hair that was cleansed with soap and water and dried. The unwashed fur had not been washed in one month.

In both tests, the dog hair that received the spray stained considerably less and did not experience fecal clumping versus the uncontrolled, untreated fur. These results evidence the effectiveness of the product provided herein.

While the unwashed and treated dog hair sample repelled feces and prevented discoloration, the washed, treated sample virtually repelled 100% of feces. This is attributed to the fact that soap (surfactant) can remove oily and/or dust substances that cling to dog hair, which cleans the surface area of the dog hair and makes the spray provided herein more effective in adhering to animal hair.

For the unwashed fur test in which the dog hair had not been washed in one month, and with non-treated instances in which continually mashed solid feces stains and adheres to the fur, the more times feces adhered to the fur, the more the feces accumulated on the fur.

For the unwashed fur test with treated instances with feces continually mashed on the dog hair, the fur stained slightly, however, mashing the feces several times did not cause accumulation.

Use Case:
1) Prior to letting the animal excrete waste, the animal handler generously applies the substance provided herein on the animal's rear fur, closest to the anus. Based on temperature, humidity, and other weather variables, the animal handler waits for a recommended five to ten minutes before taking the animal out for defecation.
2) The substance adheres to the animal's fur and creates a non-toxic hydrophobic coat around fur, repelling any feces. During defecation, the animal's feces will slide out and not clump/adhere to any hair. After defecating, the animal's rear fur should be free of feces.
3) The animal handler takes the dog indoors and repeats the process for future outings The animal handler may not have to reapply the substance for another five instances.
4) The substance may be washed off with soap and water.

What is claimed is:

1. A system for sanitary handling of animal excrement, comprising:
a mixing device that:
combines substances comprising:
an active ingredient,
a water repellent, and
a solvent to create a solution that when applied to animal fur:
binds to the fur, and
prevents animal feces from adhering to the fur.

2. The system of claim 1, wherein the solution is applied as a spray.

3. The system of claim 2, wherein the solution is of low viscosity that promotes the application as a spray

4. The system of claim 1, wherein the solution is non-toxic, is silicone-based, and is chemically stable.

5. The system of claim 1, wherein the active ingredient is an amine-based silicone that is hydrophilic.

6. The system of claim 1, wherein the solvent is a rapidly evaporating low molecular silicone.

7. The system of claim 1, wherein the water repellent is a hydrophobic silicone.

8. The system of claim 7, wherein the amine-based silicone comprises 2.5%-5.0% of volume, wherein the hydrophobic silicone comprises 1.0%-2.0% of volume, and wherein the low molecular silicone comprises 93.0%-96.5% of volume.

9. The system of claim 1, wherein the device mixes the substances for about ten minutes and places the solution in a handheld container with dispensing apparatus.

10. A method of creating a sprayable liquid solution for sanitary handling of pet feces, comprising:
a device combining an amine-based silicone substance with a hydrophobic silicone substance;
the device adding a silicone-based solvent to the combined amine-based silicone and hydrophobic silicone substances; and
the device mixing the solvent and the combined substances to create a liquid solution.

11. The method of claim 10, wherein the device mixes the solvent and the combined substances for about ten minutes.

12. The method of claim 10, wherein the device inserts the solution into a container.

13. The method of claim 12, wherein the device closes the container with the solution contained within with a spray top mechanism.

14. The method of claim 10, wherein the device mixes the amine-based silicone substance comprising 2.5%-5.0% of volume, the hydrophobic silicone substance comprising 1.0%-2.0% of volume, and the silicone-based solvent comprising 93.0%-96.5% of volume.

15. A system for storing and dispensing a material for use in sanitary handling of animal waste, comprising:
a handheld container that:
receives placement of a liquid solution,
receives placement of a cap with dispensing apparatus,
receives manual pressure against an activating component of the dispensing apparatus,
dispenses, based on the manual pressure, the solution in sprayed manner.

16. The system of claim 15, wherein the solution, when sprayed at an animal's backside, causes freshly excreted feces to slide off the backside.

17. The system of claim 15, wherein the solution comprises three ingredients comprising an amine-based silicone substance, a hydrophobic silicone substance, and a silicone-based solvent.

18. The system of claim 17, wherein the amine-based silicone substance comprises 2.5%-5.0% of volume, the hydrophobic silicone substance comprises 1.0%-2.0% of volume, and the silicone-based solvent comprises 93.0%-96.5% of volume.

19. The system of claim 17, wherein the three ingredients are mixed for about ten minutes before placement into the handheld container.

20. The system of claim 17, wherein the anime-based silicone substance is a positively charged chemical that naturally binds to negatively charged animal hair.
